(19) United States
(12) Patent Application Publication
(10) Pub. No.: US 2013/0247445 A1
(43) Pub. Date: Sep. 26, 2013

(54) Fishing Lure

(71) Applicants: Shawn L. Autrey, Willis, TX (US); Jason H. Bailey, Katy, TX (US)

(72) Inventors: Shawn L. Autrey, Willis, TX (US); Jason H. Bailey, Katy, TX (US)

(21) Appl. No.: 13/430,472

(22) Filed: Mar. 26, 2012

(51) Int. Cl. A01K 85/00

(52) U.S. Cl. 43/42.21

(57) ABSTRACT

Fishing lures are disclosed herein. An embodiment includes a fishing lure comprising: a rotatable lure body having an exterior surface, wherein the exterior surface includes one or more spaced helical grooves configured to effect rotation of the rotatable lure body during retrieval through water; and a hook coupled to the rotatable lure body, wherein the rotatable lure is configured to rotate independently of the hook; wherein the fishing lure is a topwater fishing lure.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

This invention relates generally to fishing lures and, more particularly, in one or more embodiments, to topwater fishing lures comprising a rotatable lure body.

Fishing lures have been used for years by sportsmen for both commercial gain and sport. In general, fishing lures are objects attached to the end of a fishing line that are designed to simulate natural prey of a fish as the lures are moved through the water. To attract fish, fishing lures can use, for example, movement, vibration, and/or color. Fishing lures typically include one or more hooks to hook the fish when the fish attacks a particular lure.

A wide variety of fishing lures have been developed over the years with wide variance in the style, color, size, and type of the lure. Examples of lures include jigs, top-water lures, crankbaits, artificial flies, spoons, spinnerbaits, and soft-plastic baits. Depending on the design, each type of lure will typically perform differently underwater. Despite the lures that are currently available, there exists a need for improved lures that can attract fish when moved through the water.

### SUMMARY

This invention relates generally to fishing lures and, more particularly, in one or more embodiments, to topwater fishing lures comprising a rotatable lure body.

An embodiment of the present invention includes a fishing lure. The fishing lure may comprise a rotatable lure body having an exterior surface, wherein the exterior surface includes one or more spaced helical grooves configured to effect rotation of the rotatable lure body during retrieval through water. The fishing lure may further comprise a hook coupled to the rotatable lure body, wherein the rotatable lure is configured to rotate independently of the hook. The fishing lure may be a topwater fishing lure.

Another embodiment of the present invention includes a topwater fishing lure. The top water fishing lure may comprise a rotatable lure body having an exterior surface, wherein the exterior surface includes one or more spaced helical grooves configured to effect rotation of the rotatable lure body during retrieval through water. The topwater fishing lure may further comprise a wire at least partially disposed in a longitudinal channel extending through the rotatable lure body, such that the rotatable lure body rotates about the wire, the wire comprising a forward ring at a proximal end of the wire. The topwater fishing lure may further comprise a swivel coupled to a distal end of the wire. The topwater fishing lure may further comprise a hook coupled to the swivel such that the rotatable lure body is configured to rotate independently of the hook. The topwater fishing lure may further comprise wings disposed between the rotatable lure body and the swivel. The rotatable lure body may be buoyant such that the fishing lure is configured to float on surface when the fishing lure is at rest in still water.

The features and advantages of the present invention will be apparent to those skilled in the art. While numerous changes or modifications may be made by those skilled in the art, such changes and modifications are within the spirit of the invention.

### BRIEF DESCRIPTION OF THE DRAWINGS

These drawings illustrate certain aspects of the present invention and should not be used to limit or define the invention.

FIG. 1 is a view illustrating a fishing lure in accordance with embodiments of the present invention.

FIG. 2 is a view illustrating a lure body in accordance with embodiments of the present invention.

FIG. 3 is a view illustrating an alternative fishing lure in accordance with embodiments of the present invention.

FIG. 4 is a view illustrating another alternative fish lure in accordance with embodiments of the present invention.

FIG. 5 is another view of the fishing lure of FIG. 4 in accordance with embodiments of the present invention.

### DESCRIPTION OF PREFERRED EMBODIMENTS

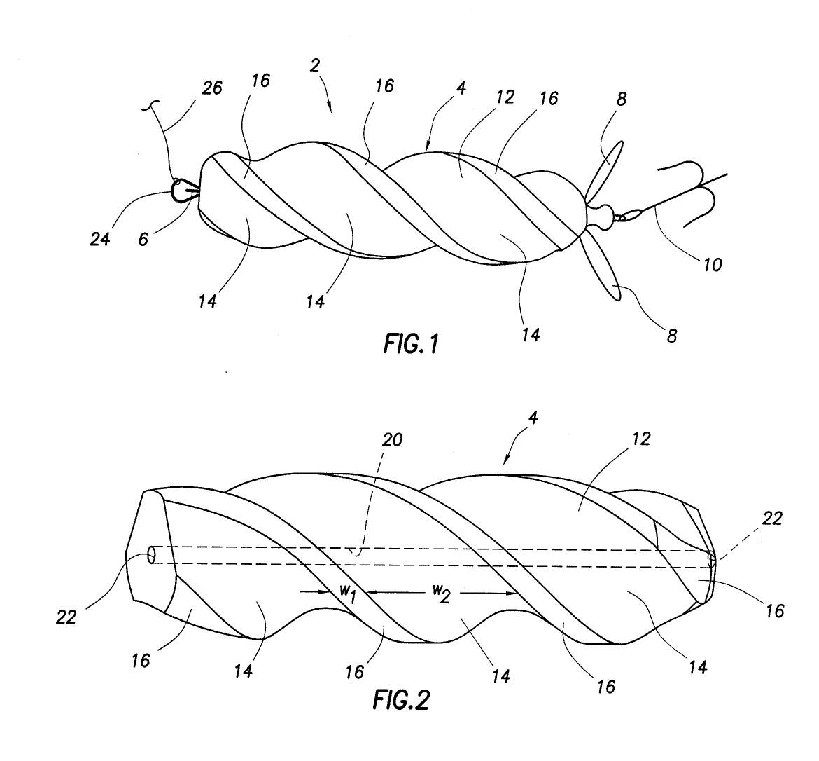

Referring now to FIG. 1, a fishing lure 2 is illustrated in accordance with embodiments of the present invention. In the illustrated embodiment, the fishing lure 2 comprises a rotatable lure body 4, a wire 6, wings 8, and a hook 10. In accordance with present embodiments, the fishing lure 2 is a topwater lure in that it moves across the water's surface as it is retrieved. As will be discussed in more detail below, the rotatable lure body 4 may be configured to rotate as the fishing lure 2 is moved through water. It is believed that rotation of the fishing lure 2 should attract fish as the fishing lure 2 is moved through water. It is further believed that rotation of the fishing lure 2 should mimic wounded prey of the fish.

The rotatable lure body 4 may be elongated in shape in that its length may be long in relation to its width. For example, the rotatable lure body 4 may have a length that is at least 2 times the width of the lure body 4. In one embodiment, the rotatable lure body 4 may be in the general shape of an elongated cylinder. In accordance with present embodiments, the rotatable lure body 4 may buoyant such that the fishing lure 2 floats on the surface when at rest in still water, which may be saltwater or freshwater, for example. In this manner, the fishing lure 2 may be moved about the surface of the water when it is retrieved. In some embodiments, the fishing lure 2 may not float in still water but could still be configured to have sufficient buoyancy to travel at the water's surface when retrieved.

The rotatable lure body 4 may be constructed from any of a variety of materials including, for example, plastics (e.g., acrylic methyl methacrylate), wood, and combinations thereof. Other suitable materials may also be used for the rotatable lure body 4. In some embodiments, the rotatable lure body 4 may be designed to allow light to pass through the body.

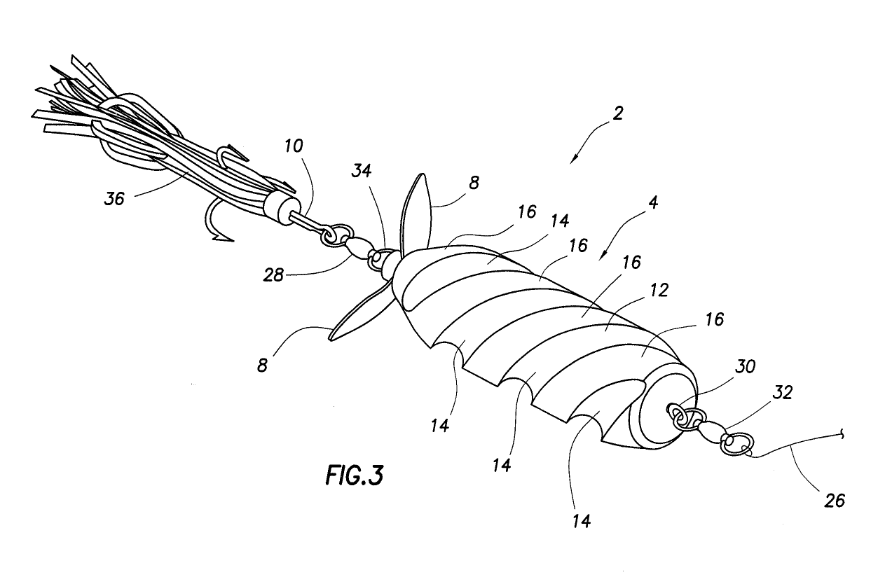

With additional reference to FIG. 2, an exterior surface 12 of the rotatable lure body 4 may include spaced helical grooves 14. In the illustrated embodiment, helical surfaces 16 are disposed between each of the helical grooves 14 in the exterior surface 12. In the illustrated embodiment, the spaced helical grooves 14 with the helical surfaces 16 extend substantially along the entire length of the exterior surface 12 of the lure body 4. In some embodiments, the spaced helical grooves 14 with the helical surfaces 16 extend substantially along at least 64% of the length of the exterior surface 12 of the lure body 4 and, alternatively at least 90% of the length of the exterior surface 12 of the lure body 4. In some embodiments, the helical grooves 14 may have a width (w1) that is at least twice the width (w2) of the helical surfaces 16 and, alternatively, at least three times the width (w2) of the helical surfaces 16, as best seen in FIG. 2.

In accordance with present embodiments, the rotatable lure body 4 may have a wide variety of different designs suitable for attracting fish. For example, the lure body 4 may be any of a variety of different colors that may be suitable for attracting fish in different conditions. By way of further example, the rotatable lure body 4 may be designed to have the general appearance of shad, crawfish, or a perch, among others. In one embodiment, the helical grooves 14 and the helical surfaces 16 may have contrasting colors and/or designs. In some embodiments, the helical grooves 14 may be designed to have the general appearance of a top portion of a bait (e.g., shad, crawfish, perch) while the helical surfaces 16 may be designed to have the general appearance of a lower portion of the bait, or vice versa. In an embodiment, the rotatable lure body 4 may include fish marks, such as eyes, scales, and the like, that may allow the fishing lure to mimic prey. By way of further example, the rotatable lure body 4 may include additional features for attracting fish, such as a skirt or a tail. In an embodiment, a skirt can be attached to the rotatable lure body 4 with the skirt extending from the distal end—with respect to the direction of retrieval of the rotatable lure body 4. In an embodiment, a tail can be attached to the rotatable lure body 4 with the tail extending from the distal end of the rotatable lure body 4.

As best seen in FIG. 2, the rotatable lure body 4 may have a longitudinal channel 20 extending therethrough. The channel 20 may be adapted to receive a portion of the wire 6. The channel 20 may have openings 22 at either end of the lure body 4.

The wire 6 may be at least partially disposed in the longitudinal channel 20 of the rotatable lure body 4. As the fishing lure 2 is moved through the water, the lure body 4 may rotate about the wire 6. A proximal end—with respect to the direction of retrieval—of the wire 6 may include a forward ring 24 configured to couple the fishing lure 2 to a fishing line 26. As the lure body 4 rotates about the wire 6, the fishing line 26 should not twist and/or tangle as the fishing lure 2 is moved through the water. A swivel 28 may be disposed at a distal end of the wire 6.

The wings 8 may be disposed on the wire 6 at a distal end of the lure body 4. In the illustrated embodiment, the wings 8 may be disposed between the rotatable lure body 4 and the swivel 28. As shown in FIG. 1, two wings 8 may be disposed on the wire 6. However, it should be understood that more or less wings 8 may be used in embodiments of the present invention. In accordance with present embodiments, the wings 6 may be configured to spin about the wire 6. In one particular embodiment, the wings 6 spin independent of the rotatable lure body 4. In another embodiment, the wings 6 are secured to a distal end of the rotatably lure body 4 such that the blades 6 spin with the lure body 4.

The hook 10 may be coupled to the swivel. While a treble hook is illustrated. it should be understood that the present invention encompasses the use of other hooks with the fishing lures disclosed herein. In addition, while one hook 10 is illustrated, the present invention contemplates using one or more hooks 10 as needed for a particular application. While not illustrated in FIG. 1, the hook 10 may include a skirt or a tail coupled thereto.

The fishing lure 2 may have a variety of sizes depending, for example, on the particular application. For example, a larger lure may be desired in some instances, such as saltwater fishing. In accordance with certain embodiments, the fishing lure 2 may have a length of from about 2 inches to about 12 inches, and, in other embodiments, from about 2 inches to about 5 inches. In accordance with present embodiment embodiments, the fishing lure 2 may be buoyant in freshwater, seawater, or both freshwater and seawater.

The following is a description of one suitable technique for use of the fishing lure 2 in accordance with embodiments of the present invention. In operation, the forward ring 24 of the fishing lure 2 can be secured to the fishing line 26, as shown on FIG. 1. A fisherman can cast or lower the fishing lure 2 into the water to be fished. The fishing lure 2 can then be moved through the water by subsequent retrieval, jigging, or trolling, for example. As the fishing lure 2 is moved through the water, the helical grooves 14 on the rotatable lure body 4 are adapted to rotate the fishing lure 2. As the lure body 4 rotates about the wire 6, the fishing line 26 should not twist and/or tangle as the fishing lure 2 is moved through the water. The swivel 28 should generally allow the fishing lure 2 to rotate independently of the hook 10. It is believed that rotation of the fishing lure 2 in the water should attract fish. It is further believed that rotation of the fishing lure 2 should mimic wounded prey of the fish.

Referring now to FIG. 2, a fishing lure 2 is illustrated in accordance with alternative embodiments of the present invention. In the illustrated embodiment, the fishing lure 2 comprises a rotatable lure body 4, wings 8, and a hook 10. In accordance with present embodiments, the rotatable lure body 4 may include an exterior surface 12 having spaced helical grooves 14 wherein helical surfaces 16 may be disposed between each of the helical grooves 14 in the exterior surface 12. As illustrated, a distal end of the lure boy 4 may taper to a blunt end while the proximal end may be blunt. In the illustrated embodiment, the rotatable lure body 4 includes a forward ring 30 at a proximal end thereof. A swivel 32 may be attached to the forward ring 30 with the swivel 32 coupled to the fishing line 26. As illustrated, the rotatable lure body 4 further may include a rear ring 34 at a distal end thereof. A swivel 28 may be coupled to the rear ring 34 with the swivel 28 coupled to the hook 10. In the illustrated embodiment, the hook 10 includes a skirt 36. The rotatable blades 8 may be coupled to the lure body 4 as shown by FIG. 3.

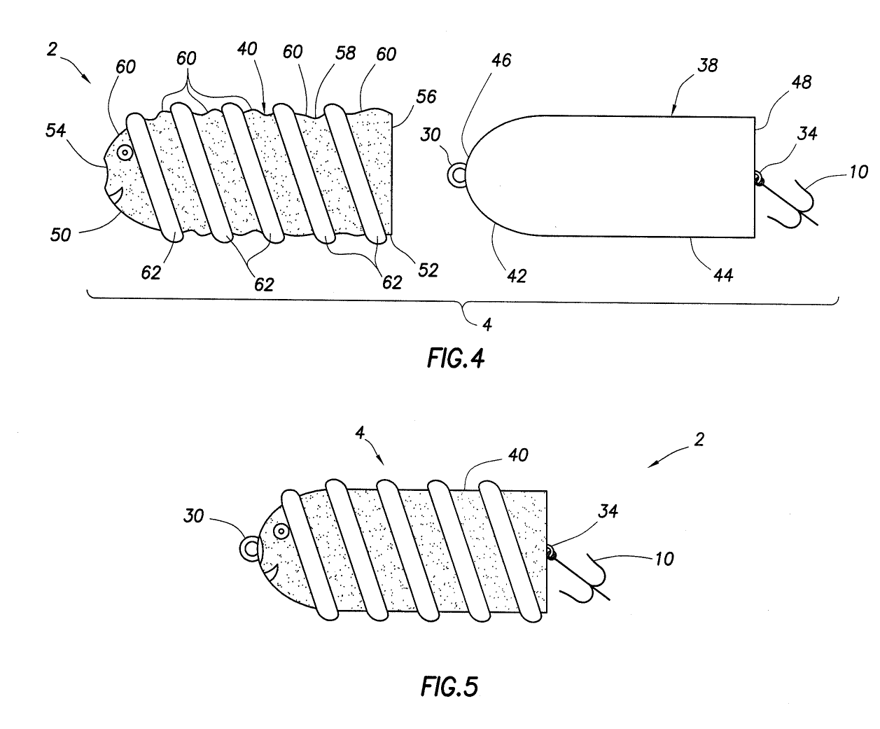

Referring now to FIGS. 4 and 5, a fishing lure 2 is illustrated in accordance with alternative embodiments of the present invention. As illustrated, the fishing lure 2 comprises a rotatable lure body 4 and a hook 10. In the illustrated embodiment, the rotatable lure body 4 comprises a lure core 38 and a removable sleeve 40 that may be placed over the lure core 38. As illustrated, the lure core 38 includes a head portion 42 and a cylindrical body portion 44 with the head portion 42 extending from one end of the cylindrical body portion 44. While the body portion 44 is illustrated as being generally cylindrical in nature, it should be understood that other shapes for the body portion 44 are encompassed within the present invention. In an embodiment, the head portion 42 tapers from the cylindrical body portion 44 to a blunt end 46.

Embodiments of the lure core 38 may further include a forward ring 30 positioned at the blunt end 46 of the head portion 42. The forward ring 30 can be adapted to secure the fishing lure 2 to a line so that the lure 2 can be moved through the water. Additional embodiments of the lure core 38 may further include a rear ring 34 positioned at the trailing end 48 of the cylindrical body portion of the lure core. The rear ring 34 may be used to secure any of a variety of different devices to the lure core, including for example, swivels, hooks, lures, trailers, leaders, combinations thereof, and the like. In the illustrated embodiment, the rear ring 34 secures a hook 10 to the lure core 38. While a treble hook is illustrated, it should be understood that the present invention encompasses the use of other hooks with the fishing lure 2 disclosed herein.

The lure core 38 may be constructed from any of a variety of suitable materials including, for example, plastics (e.g., acrylic methyl methacrylate), wood, and combinations thereof. Other suitable materials may also be used for the lure core 38. In accordance with present embodiments, the lure core 38 may buoyant such that the fishing lure 2 floats on the surface when at rest in still water, which may be saltwater or freshwater, for example. In this manner, the fishing lure 2 may be moved about the surface of the water when it is retrieved. In some embodiments, the fishing lure 2 may not float in still water but could still be configured to have sufficient buoyancy to travel at the water's surface when retrieved. The lure core 38 can be designed to allow light to pass through the lure core 38. As will be discussed in more detail below with respect to FIG. 6, a light source may be incorporated within the lure core 38, allowing the fishing lure 2 to transmit light when under water to further attract fish, for example. In an embodiment, the lure core 38 comprises a transparent material. In another embodiment, the lure core 38 comprises a translucent material.

The removable sleeve 40 may be adapted and configured to be placed over the lure core 38 in accordance with embodiments of the present invention. Multiple sleeves 40 may be provided with a lure core with each sleeve 40 configured to be placed over the lure core 38. The sleeves 40 may have different designs and/or configurations, allowing the fisherman to select a particular sleeve 40 for use with the lure core 38 based, for example, on the particular water conditions. As illustrated, the removable sleeve 40 includes a proximal end 50 and a distal end 52. In the illustrated embodiment, the proximal end 50 of the removable sleeve 40 includes a forward opening 54. In an embodiment, the opening 54 is sized to receive the forward ring 30 of the lure core 38. A rear opening 56 can be located at the distal end 52 of the removable sleeve 40. In one embodiment, the rear opening 56 is sized to receive the lure core 38. In an exemplary embodiment, the removable sleeve 40 can be placed over the lure core 38 with the head portion 42 being inserted first into the rear opening 56 followed by the body portion 44.

In the illustrated embodiment, an exterior surface 58 of the removable sleeve 40 may include spaced helical grooves 60. In the illustrated embodiment, helical surfaces 62, such as ridges may be disposed between each of the helical grooves 60 in the exterior surface 58. As the fishing lure 2 is moved through the water, the spaced helical grooves 60 should cause the fishing lure 2 to rotate about its longitudinal axis.

The removable sleeve 40 may be constructed from any of a variety of suitable materials including, for example, elastomers, silicone, and combinations thereof. In general, embodiments of the removable sleeve 40 may have sufficient elasticity to allow the removable sleeve 40 to slide over the lure core 38 without undesired deformation. In one embodiment, the removable sleeve 40 can be designed to allow light to pass through the sleeve 40. In an embodiment, the removable sleeve 40 comprises a transparent material. In another embodiment, the removable sleeve 40 comprises a translucent material.

The removable sleeve 40 may have a wide variety of different designs suitable for attracting fish. For example, the removable sleeve 40 may be any of a variety of different colors that may be suitable for attracting fish in different conditions. By way of further example, the removable sleeve 40 may be designed to have the general appearance of shad, crawfish, or a perch, among others. In an embodiment, the removable sleeve 40 may include fish marks, such as eyes, scales, and the like, that may allow the fishing lure to mimic prey. By way of further example, the removable sleeve 40 may include additional features for attracting fish, such as a skirt or a tail. In an embodiment, a skirt can be attached to the removable sleeve 40 with the skirt extending from the distal end 52 of the removable sleeve 40. In an embodiment, a tail can be attached to the removable sleeve 40 with the tail extending from the distal end 52 of the removable sleeve 40.

Although the present invention and its advantages have been described in detail, it should be understood that various changes, substitutions and alterations may be made herein without departing from the spirit and scope of the invention as defined by the appended claims. Although individual embodiments are discussed, the invention covers all combinations of all those embodiments. While apparatus and methods are described in terms of “comprising,” “containing,” “having,” or “including” various components or steps, the apparatus and methods can also “consist essentially of” or “consist of” the various components and steps.

What is claimed is:

1. A fishing lure comprising:
a rotatable lure body having an exterior surface, wherein the exterior surface includes one or more spaced helical grooves configured to effect rotation of the rotatable lure body during retrieval through water; and
a hook coupled to the rotatable lure body, wherein the rotatable lure is configured to rotate independently of the hook;
wherein the fishing lure is a topwater fishing lure.

2. The fishing lure of claim 1, wherein the rotatable lure body is elongated in shape.

3. The fishing lure of claim 1, wherein the rotatable lure body is buoyant such that the fishing lure is configured to float on surface when the fishing lure is at rest in still water.

4. The fishing lure of claim 1, wherein helical surfaces are disposed between the spaced helical grooves, and wherein the spaced helical grooves and helical surfaces extend at least 80% of the length of the rotatable lure body.

5. The fishing lure of claim 4, wherein the spaced helical grooves have a width that is at least twice a width of the helical surfaces.

6. The fishing lure of claim 4, wherein the helical surfaces and the helical grooves have contrasting colors and/or designs.

7. The fishing lure of claim 1, further comprising a wire, wherein the wire is at least partially disposed in a longitudinal channel extending through the rotatable lure body, such that the rotatable lure body rotates about the wire.

8. The fishing lure of claim 7, wherein the wire comprise a forward ring.

9. The fishing lure of claim 7, wherein a distal end of the wire comprises a swivel coupled to the hook.

10. The fishing lure of claim 1, wherein the fishing lure comprises wings disposed at a distal end of the rotatable lure body.

11. The fishing lure of claim 1, wherein the hook comprises a treble hook.

12. The fishing lure of claim 1, wherein the rotatable lure body comprises a ring at a proximal end and another ring at a distal end.

13. The fishing lure of claim 1, wherein the rotatable lure body comprises a lure core and removable sleeve configured for placement of the lure core, wherein the removable sleeve has the exterior surface with the one or more spaced helical grooves.

14. The fishing lure of claim 1, wherein the rotatable lure body comprises a body portion and a head portion, wherein the head portion is threadedly coupled to the body portion.

15. The fishing lure of claim 1, wherein the hook comprises a skirt.

16. A topwater fishing lure comprising:
a rotatable lure body having an exterior surface, wherein the exterior surface includes one or more spaced helical grooves configured to effect rotation of the rotatable lure body during retrieval through water;
a wire at least partially disposed in a longitudinal channel extending through the rotatable lure body, such that the rotatable lure body rotates about the wire, the wire comprising a forward ring at a proximal end of the wire;
a swivel coupled to a distal end of the wire;
a hook coupled to the swivel such that the rotatable lure body is configured to rotate independently of the hook; and
wings disposed between the rotatable lure body and the swivel;
wherein the rotatable lure body is buoyant such that the fishing lure is configured to float on surface when the fishing lure is at rest in still water.

17. The topwater fishing lure of claim 16, wherein the hook comprises a skirt.

18. The topwater fishing lure of claim 16, wherein helical surfaces are disposed between the spaced helical grooves, and wherein the spaced helical grooves and helical surfaces extend at least 80% of the length of the rotatable lure body.

19. The topwater fishing lure of claim 18, wherein the spaced helical grooves have a width that is at least twice a width of the helical surfaces.

20. The topwater fishing lure of claim 16, wherein the rotatable lure body comprises a lure core and removable sleeve configured for placement of the lure core, wherein the removable sleeve has the exterior surface with the one or more spaced helical grooves.
